(19) United States
(12) Patent Application Publication
(10) Pub. No.: US 2008/0041794 A1
(43) Pub. Date: Feb. 21, 2008

(54) Methods of decontaminating water, catalysts therefor and methods of making catalysts

(75) Inventor: Vishal Shah, Moriches, NY (US)

Correspondence Address: Daniel P. Burke, Esq.;DANIEL P. BURKE & ASSOCIATES, PLLC, Suite 131, 300 Rabro Drive, Hauppauge, NY, 11788, US

(73) Assignee: Dowling College

(21) Appl. No.: 11/893,875

(22) Filed: Aug. 16, 2007

Related U.S. Application Data
(60) Provisional application No. 60/838,525, filed on Aug. 17, 2006.

(51) Int. Cl. C02F 1/72

(52) U.S. Cl. 210/759

(57) ABSTRACT

Methods of decontaminating water, catalysts therefor and methods of making catalysts for decontaminating water to neutralize contaminants including organic and non-organic contaminants, such as aromatic compounds and microorganisms, e.g. bacteria. A heterogeneous catalyst is formed by incubating a polymeric resin with a transition metal-salt solution, e.g. a CuSO₄ solution. The contaminated water is treated by immersing the resulting heterogeneous catalyst in the contaminated water with hydrogen peroxide.

### RELATED APPLICATION DATA

This application claims the benefit of U.S. provisional patent application Ser. No. 60/838,525 filed Aug. 17, 2006.

The present invention is directed to methods of decontaminating water, catalysts therefor and methods of making catalysts. Various embodiments of the present invention utilize at least one catalyst comprising a transition metal.

### BACKGROUND

Complexes for and methods of treating contaminated water are useful in various applications. Widespread water accumulation in cities and towns with water reaching depths in excess of three meters can result from various natural disasters including floods and hurricanes. For example, Hurricane Katrina and other storms in 2005 brought heavy winds and rain across the Gulf coast of the United States. Similarly, Hurricane Floyd and other storms in 1999 caused widespread flooding of eastern North Carolina.

Consequently, high levels of fecal coliforms and other pathogenic micro-organisms were present in the accumulated flood water. Such micro-organisms can come from septic tanks, sewage treatment plants, pipelines, soil, decaying organic matter, etc. Such accumulated flood water can also contain carcinogenic and/or mutagenic compounds such as poly-aromatic hydrocarbons (PAHs), poly-chlorinated biphenyls (PCBs) and other harmful aromatic wastes. Some of these contaminants are naturally present in soil, but when flood water saturates the top layers of soil, these contaminants can percolate into water. Contaminated flood water is a major human health risk and, without simple, cost effective methods of treating and/or decontaminating such contaminated flood water, total evacuations of populated areas can be ordered post flooding to protect people from coming in contact with the pollutants.

In addition to human health risk, when flood water with elevated concentrations of various contaminants is pumped out to a natural body of water, environmental concerns arise. The contaminants also pose the risk of spreading from a confined area to a large open geographical area over time. The spread of contaminants can result in health hazards to human and other life, pose high costs for the monitoring and remediation of lakes, rivers and/or shores where the contaminants may spread, and adversely influence bio-diversity across the region. For example, concern was widely expressed about the ultimate environmental effects of contaminated flood water from New Orleans on Lake Pontchartrain after Hurricane Katrina.

Thus, a need exists to treat contaminated water, including but not limited to flood water resulting from natural disasters and other manners of contamination including pollution, spills, and terrorist attacks.

It would be particularly desirable to provide water treatment methods which are simple and can be performed with minimal training by personnel such as soldiers and emergency responders, requires no parasitic energy input, does not impermissibly contaminate the treated water, is cost effective and can be performed in the field quickly.

Advanced oxidation process (AOP) is one of the promising methods for waste water treatment. The method is based on the generation of oxygen radicals, which can be used for nonspecific oxidation of a wide range of organic compounds. AOPs include the classical Fenton reaction, its modifications (e.g. light assisted Fenton oxidation or ferrioxalate-photo Fenton oxidation), as well as H₂O₂/UV or ozonization. Fenton's reaction involves the use of transition metals (mainly iron and copper) along with hydrogen peroxide to produce hydroxyl radicals (equation 1).

Fe⁺²+H₂O₂→Fe⁺³+OH⁻+OH⁻

However, generation of radicals through classical or modified Fenton's system are not suitable for treatment of vast water bodies such as flood water since they require secondary processes for removal of the metals from the water. Ozonization would involve using UV rays on a very large scale and would, therefore, be technically unfeasible.

Homogenous catalytic systems are not suitable for the treatment of waste water since they also require secondary processes for removal of the catalysts from the water. To date, each of these processes have been technically and/or economically unfeasible.

Polymers are available in the market for removing transition metals and heavy metals from solution and for immobilizing those metals. Such polymers are widely used for water purification, electrodialysis, electrodeposition paint processes and general electrochemical separations. But such polymers will not effectively remove sufficient amounts of bacteria and aromatic compounds.

### SUMMARY OF THE INVENTION

Embodiments of the present invention are believed to utilize polymer-metal-radical complexes for treating contaminated water. Other embodiments include methods of making such polymer-metal catalysts, and the methods of decontaminating water to neutralize contaminants including organic and non-organic contaminants, such as aromatic hydrocarbons and microorganisms, e.g. bacteria. The present invention can be used to neutralize contaminants in small or large bodies of water, such as accumulated flood waters, lakes, rivers, ponds and pools or even for small quantities of water, e.g. a few liters. As used herein, the term “decontamination” refers to the neutralization of contaminants in water. The resulting water is preferably, but not necessarily, potable.

The water treatment methods of the present invention are based upon production of oxygen radicals through reaction of a ligand bound transition metal with hydrogen peroxide. A heterogeneous catalyst is formed by incubating a polymer resin with a transition metal-salt solution, e.g. a CuSO₄ solution. Suitable transition metals are copper, iron, manganese, cobalt, and mixtures thereof. The incubation is preferably performed for a predetermined period of time, followed by removing excess CuSO₄ solution and preferably, but not necessarily, allowing the polymer complex to dry. The contaminated water is treated by immersing the resulting heterogeneous catalyst in the contaminated water with hydrogen peroxide.

### BRIEF DESCRIPTION OF THE DRAWINGS

FIG. 1 is an illustrative figure showing an embodiment of a copper-polymer complex and the targeted contaminants.

FIG. 2 is a table setting forth the reduction of various bacterial cultures through treatment of contaminated water by a complex and method of the present invention for a period of 15 minutes.

FIG. 3 is a chart illustrating the results of an experiment conducted using a complex and method of the present invention on samples of contaminated water that was taken from actual flood water.

FIG. 4 is an illustrative figure of one embodiment of the present invention wherein contaminated water is pumped into a system.

### DETAILED DESCRIPTION

Various embodiments of the present invention include methods of treating contaminated water, and methods of preparing the polymer-metal-radical complexes themselves. As used herein, the term “heterogeneous catalyst” is used to indicate that the catalyst is in a solid phase and is insoluble in the water being treated. As used herein, the term “purifying” or “to purify” refers to the removal of one or more undesired components from a sample. As used herein, the term “neutralize” refers to rendering an otherwise harmful contaminant harmless. As used herein, the term “decontaminate” refers to neutralizing at least one microbial contaminant and/or an aromatic compound.

The heterogeneous catalyst used for removing contaminants from water is prepared with a polymer, i.e. cationic ion exchange resin and a transition metal solution. It is believed that a copper salt solution, such as a CuSO₄ solution, is preferable, so the examples and description herein will refer to CuSO₄. It is also possible to use other transition metal salts.

According to one embodiment, the polymeric complex used to prepare the heterogeneous catalyst is an ion exchange resin, such as Amberlite® IRC 748, Amberlyst® 15 WET or Amberlyst® 16 WET which are commercially available from the Rohm & Haas Company, Philadelphia, USA. The specific catalysts are exemplary. Other cationic ion exchange resins, whether in the form of beads or sheets can be utilized.

According to another embodiment, the polymeric complex used to prepare the heterogeneous catalyst can be an ion-exchange sheet, such as commercially available polymeric sheets such as P-81 available from Whatman, Inc. of Middlesex, U.K. and CMI-7000S which is commercially available from Membranes International, Inc. of Glen Rock, N.J., USA.

One method of preparing a heterogeneous catalyst with an ion exchange resin, comprises incubating the resin with a transition metal salt solution for a predetermined period of time. The excess transition metal salt solution is removed and excess transition metal is removed from the catalyst, for example by rinsing the catalyst with water, preferably distilled water. The resin may be dried until it reaches a constant weight. The starting transition metal salt solution preferably comprises at least about 0.5 milliMoles of the transition metal salt in water, preferably at least about 0.75—about 1 mM. From the present description, those skilled in the art will appreciate that it is desirable to avoid an excess of transition metal on the resulting catalyst in order to minimize leaching of the transition metal into the treated water. The amount of transition metal in the starting solution should be adjusted and will depend upon the type of polymeric resin being used. For example, those skilled in the art will appreciate that some resins will present the active catalytic component in such a way that the component, e.g. copper, is more exposed for quicker catalytic reactions The ion exchange resin is incubated with the transition metal salt solution at a predetermined temperature of a range of approximately 10-40° C., preferably about 25-30° C.

The precise conditions of the incubation, such as the temperature, length of time in which the resin is incubated in the transition metal salt solution, and other conditions such as whether the resin is simply dipped into a transition metal salt solution or possibly put into a shaker, will depend mainly upon the type of resin being used. From the present description, those skilled in the art will appreciate that different base resins have different catalytic properties, typically measured in ion exchange capacity. A resin with a higher ion exchange capacity may need less incubation time, as well as less transition metal in the resulting polymer-metal-radical complex, on a weight-weight basis, in order to be effective. For some starting resins, during incubation the resin and transition metal salt solution can be shaken, for example in a shaker at a range of 0-300 rpms. Incubation can be continued for a period of seconds, e.g. 30 seconds, and up to hours, e.g. 24 hours.

According to another embodiment, the heterogeneous catalyst can also be prepared by incubating the ion exchange resin with a transition metal salt solution for a predetermined time and subsequently rinsing the resin with distilled water to remove excess transition metal salt solution. After rinsing, the catalyst can be dried or used without drying.

According to another embodiment, the heterogeneous catalyst is prepared with ion-exchange sheets wherein the sheets are cut to a predetermined size before or after being incubated, with a transition metal salt solution. The treated ion-exchange sheets are preferably subsequently rinsed with distilled water.

As noted above, examples of commercially available ion exchange sheets are P-81 and CMI-7000S. P-81 is a thin cellulose phosphate paper and a strong cation exchanger of high capacity. P-81 has an ion exchange capacity of 18.0 μeq/cm². The polymer CMI-7000S is a thin cation exchange polymer which has physical properties which are believed preferable to those of P-81 for these purposes. The ion exchange capacity of CMI-7000S is 1.3 meq/g.

The present methods of decontaminating water include the steps of placing the prepared heterogeneous catalyst into the contaminated water and adding hydrogen peroxide. During the decontamination process, hydrogen peroxide is converted to water. The decontamination occurs by the formation of hydroxyl radicals through the decomposition of hydrogen peroxide by the transition metal, e.g. copper. Free radicals generated by the polymer-copper-hydrogen peroxide system will kill the micro-organisms, and neutralize the poly-aromatic hydrocarbons and other hazardous aromatic hydrocarbons. In order to minimize contamination of the water by the radical-copper-polymer complex, the complex is washed with water prior to immersion in the water to be treated in order to remove any unbound copper. The amount of copper which leaches into the water being treated is thereby reduced.

In addition to killing microbial contaminants in the water being treated, the treatment methods of the present invention can be used to degrade aromatic compounds such as poly-aromatic hydrocarbons, textile dyes, pesticides, and phenols.

The catalyst used preferably has a transition metal, e.g. copper, concentration of about 0.01-60%, preferably about 5-40% and most preferably about 20-30% (w/w) relative to the resin. However, other concentrations are possible within the scope of the present invention .

In general, the method of treating contaminated water according to the present invention involves the steps of:
a. Chelating copper on a ion-exchange resin to form the catalyst.
b. Adding the catalyst and hydrogen peroxide to water containing microbial contaminants and/or aromatic contaminants.

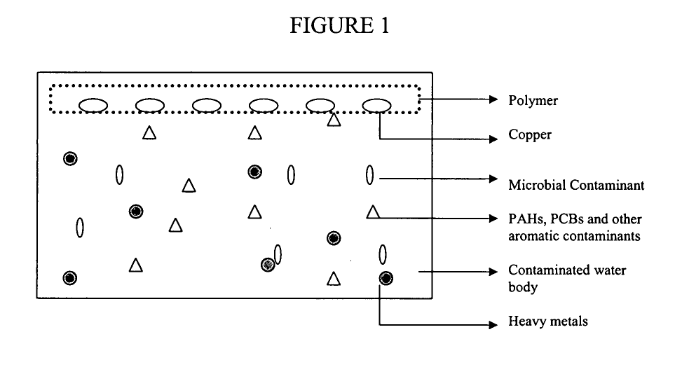

FIG. 1 is an illustrative figure showing the system of the present invention with targeted contaminants.

### EXAMPLE 1

Materials: Ion-exchange resins were obtained from Rohm and Haas Company, Philadelphia, USA. Bacterial cultures were obtained as gift from Prof. Richard Gross, Brooklyn, N.Y. All other chemicals were obtained from Sigma-Aldrich Chemical Co. and were used as received unless otherwise stated.

Preparation of heterogeneous catalyst: 1 g of ion-exchange resin was incubated in a shaker with 33 ml of 100 mM CuSO₄ solution at 30° C. and 200 rpm for 24 hours. Then, the excess CuSO₄ solution was decanted and the treated resin was left to dry in air at 30° C. till constant weight, approximately 24 hours.

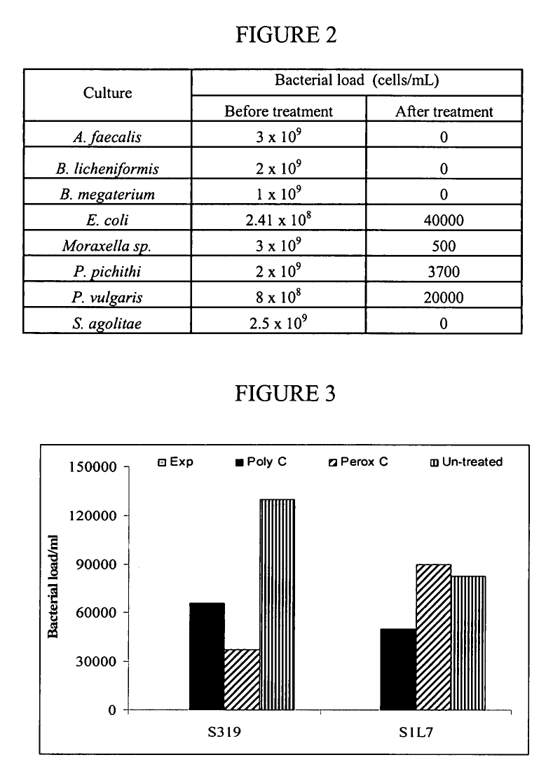

FIG. 2 is a table that illustrates the ability of the catalyst-peroxide system to treat water contaminated with various types of bacteria. Bacterial load was reduced in these instances by more than 99.9% in 15 minutes in almost all cases. The system of the present invention is effective against gram +ve and gram −ve bacteria. Control samples having only hydrogen peroxide or catalyst had no influence on the microbial load.

From the water quality perspective, the process composition is desirably constant and effective for decontaminating water irrespective of the microbial load. Considering that once the flood water accumulates in the human habitat, it is desirable to treat the water as soon as possible. Determining culture load is time consuming as it involves water sampling, shipping and either microscopy or plating methods. Also, the culture loads may vary from one sampling site to another. Therefore, the ability to treat contaminated water having a wide range of microbial counts is highly advantageous.

The present methods do not depend on microbial load in the water. Indeed, when treatment of E. coli contaminated water was carried out as a function of time and culture load, it was observed that the bacterial count decreases as time progresses. When the initial cell count was 2.4×10⁸ cells/mL, the bacterial load was reduced by more than 99% within 10 minutes of treatment. 100% decontamination was achieved within 40 minutes.

When the initial culture load was increased to 1.4×10⁹, after 90 minutes of incubation, the same concentration of catalyst and peroxide was able to reduce the bacterial load to 40×10³ cells/mL. It took 60 minutes to achieve 100% decontamination of an intermediate concentration of E. coli (1.1×10⁹ cells/mL). Control samples showed no reduction in bacterial load as a function of time. Thus, when the water has a higher culture load, the decontamination time is longer compared to the decontamination time needed for the lower load of culture in water. However, the composition and effectiveness of catalyst and peroxide needed to treat water is independent of culture load.

Water samples collected from flood affected areas on the Gulf Coast were also treated. The samples came from two canals of New Orleans: the 17^{th} Street Canal and the Industrial Canal. The 17^{th} Street Canal was widely televised and, in terms of stable istopes, nutrients and bacterial community, this water sample represented the floodwater. The Industrial Canal is a deep shipping canal that connects Lake Pontchartrain to the Mississippi and can be compared to the water of Lake Pontchartrain. As shown in FIG. 3, 100% decontamination was achieved by treating the water for 15 minutes using a method of the present invention. FIG. 3 shows that the decontamination treatment labeled “Exp” resulted in 0 microbial cells/ml. Polymeric resin control and peroxide control alone were not very effective in bacterial decontamination.

Experiments involving removal of aromatic compounds such as phenanthrene and naphthalene (initial concentration were 10 ppm) resulted in more than 65% removal of both compounds in less than 1 hour.

The mechanism of action of decontamination is believed to be the formation of hydroxyl radicals through the decomposition of hydrogen peroxide by the copper. A qualitative assay for hydroxyl radicals was performed using a deoxyribose degradation assay. Formation of pink color was be observed immediately confirming the production of hydroxyl radicals. However, it seems that the hydroxyl radicals formed are not free in the system but remain complexed with the catalyst forming polymer-copper-radical complex(es). The proof can be obtained from the spin trapping experiments with DMPO. Free hydroxyl radicals are trapped by DMPO (5,5-Dimethyl-1-pyrroline N-oxide) and a 1:2:2:1 quadratet of hydroxyl radical-DMPO adduct is seen in the region of 3300-3400 H. When the spin trap experiment was carried out, no radicals were observed in the EPR (Electron paramagnetic resonance) spectrum.

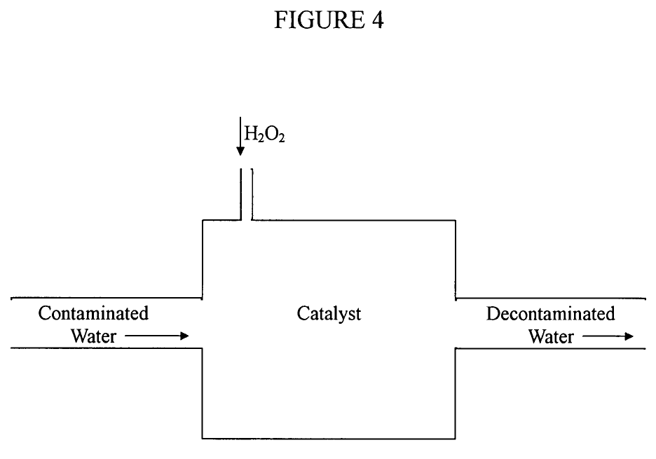

The novel catalysts, methods for forming those catalysts and decontamination methods of the present invention can also be used in relatively closed systems such as by pumping contaminated water, along with a supply of hydrogen peroxide, through a cartridge or other space comprising a catalyst of the present invention. FIG. 4 generally illustrates such a system. Such systems can also comprise one or more filters and valves as desired. Thus, the methods of the present invention can be used to decontaminate flood water, and can be easily adapted for decontaminating large water bodies such as ponds, lakes or swimming pools. Not only can they remove metals, poly-aromatic hydrocarbons and bacteria from contaminated water but they can also treat algal blooms that might be of concern in various water bodies. The present method can also be modified/utilized for treating industrial and municipal effluents.

1. A method of decontaminating water comprising the steps of:
providing a polymeric catalyst comprising
at least one bound transition metal; and
placing said polymeric resin into contact with contaminated water with hydrogen peroxide.

2. A method of decontaminating water according to claim 1 wherein said transition metal is copper.

3. A method of decontaminating water according to claim 1 wherein said transition metal is iron.

4. A method of decontaminating water according to claim 1 wherein said transition metal is cobalt.

5. A method of decontaminating water according to claim 1 wherein said transition metal is manganese.

6. A method of decontaminating water according to claim 2 wherein said catalyst is in the form of a sheet.

7. A method of decontaminating water according to claim 2 wherein said catalyst is in the form of beads.

8. A method of decontaminating water according to claim 1 wherein said catalyst is in the form of a sheet.

9. A method of decontaminating water according to claim 8 wherein said transition metal is copper.

10. A method of decontaminating water according to claim 8 wherein said transition metal is iron.

11. A method of decontaminating water according to claim 1 wherein said catalyst is in the form of beads.

12. A method of decontaminating water according to claim 11 wherein said transition metal is copper.

13. A method of decontaminating water according to claim 11 wherein said transition metal is iron.

14. A method of decontaminating water according to claim 1 wherein said step of providing said catalyst comprises providing a cationic ion exchange resin which has been incubated with a solution of a copper salt.

15. A method of decontaminating water according to claim 14 wherein said solution has a starting copper-salt concentration of at least 0.5 mM of copper.

16. A method of decontaminating water according to claim 1 wherein said catalyst has a weight-weight transition metal concentration of about 0.1-60%.

17. A method of decontaminating water according to claim 1 wherein said catalyst has a weight-weight transition metal concentration of about 10-50%.

18. A method of decontaminating water according to claim 1 wherein said catalyst has a weight-weight transition metal concentration of about 20-30%.

19. A method of decontaminating water according to claim 1 wherein said contacting step comprises pumping contaminated water through a system comprising said catalyst and a supply of hydrogen peroxide.

20. A method of preparing a heterogeneous catalyst for use in decontaminating water comprising the steps of:
providing a cationic ion exchange polymeric resin;
incubating said polymeric resin with a transition metal solution; and
removing said polymer complex from said transition metal solution.

21. A method according to claim 20 wherein said polymeric resin is in the form of a granular resin.

22. A method according to claim 20 wherein said polymeric resin is in the form of a polymeric sheet.

23. A method according to claim 20 wherein the transition metal is copper.

24. A heterogeneous catalyst for use in decontaminating water comprising a polymeric cationic ion exchange resin and a transition metal bound to said resin.

25. A heterogeneous catalyst according to claim 24 when said transition metal is copper.

26. A heterogeneous catalyst according to claim 24 when said transition metal is iron.

27. A heterogeneous catalyst according to claim 24 when said transition metal is cobalt.

28. A heterogeneous catalyst according to claim 24 when said transition metal is manganese.
